(19) United States
(12) Patent Application Publication
(10) Pub. No.: US 2015/0019423 A1
(43) Pub. Date: Jan. 15, 2015

(54) TRANSACTIONAL RECONCILIATION SYSTEM AND METHOD

(71) Applicants: BARRY DOWLING, Dublin (IE); Sinead Fitzmaurice, Co. Wexford (IE)

(72) Inventors: BARRY DOWLING, Dublin (IE); Sinead Fitzmaurice, Co. Wexford (IE)

(21) Appl. No.: 13/941,912

(22) Filed: Jul. 15, 2013

(51) Int. Cl. G06Q 20/10

(52) U.S. Cl. CPC G06Q 20/108
USPC 705/42

(57) ABSTRACT

Provided are a computer-implemented method and system in the form of an integrated application programming interface (API) for booking payments entered in an accounting software application, comprising: receiving a user's selection of invoices to be paid in a user interface; determining the total value of invoices to be paid; allowing the user to select a currency exchange rate provided to transfer the monies due from a bank account of the user to a beneficiary account of each of the one or more suppliers; receiving a user's selection of currency exchange rate and payment approval; executing the funds transfer to each of the beneficiary accounts; allowing the user to automatically post the funds transfer to the accounting software application once confirmation of the funds transfer is received; and automatically posting an exchange gain or loss in the accounting software application based on the funds transfer.

### RELATED APPLICATIONS

This present application claims priority from U.S. Patent Application Ser. No. 61/671,248, filed 13 Jul. 2012, which is incorporated herein in its entirety.

### FIELD OF THE INVENTION

The present invention relates to a transactional reconciliation system and method particularly usefully provided as a computer-implemented method for booking payments entered in an accounting software application, and in particular to a system which provides exchange rate booking for users using an online web service.

### BACKGROUND

Accounting software applications provide small businesses through to medium and large-sized companies with business software solutions such as managing cash flow and budgets, monitoring business performance and controlling and sharing information.

Within this context, different services providers offer different software packages to assist in the accounting and bookkeeping activities. It is not uncommon for the same service provider to offer different versions, for ease of convenience here termed: Basic, Advanced and Professional. Each of these versions provides specific functionality for a target market sector. The key difference, which is relevant to the present teaching, relates to the functionality to handle foreign currency supplier invoices. It is not unusual for advanced functionality such as for example handling of foreign currency supplier invoices to be restricted to a Professional version.

Where the software version is not capable of actually handling such foreign currency transactions there are different approaches to enable a user enter such data for reconciliation and accounting purposes.

In the first way, when a foreign currency invoice is received from the supplier, the user posts the invoice into the software package with the actual value of the invoice. When payment is made to the supplier, the actual exchange gain or loss is posted as a separate invoice or credit note on the suppliers account, and with a specific nominal account distribution. For example: If an invoice is received from a sterling supplier for £100.00 to a Euro base account system, then the user enters the invoice into the accounts package as [symbol] 100.00 When the invoice is paid the total amount payable maybe around [symbol] 121.00, in which case the user creates an additional invoice for a specific nominal for the difference in amount which in this case is [symbol] 21.00. In this context users are aware of the supplier currency type when completing the transaction.

In the second method, when a foreign currency invoice is received from the supplier, the user converts the foreign currency value to the base currency using an estimated exchange rate. When payment is made to the supplier, the actual exchange gain or loss is posted as a separate invoice or credit note to a specific nominal account. For example: If an invoice is received from a sterling supplier for £100.00 then the user uses an estimated exchange rate (e.g. 0.8945) to convert the foreign currency invoice into a base currency invoice for the value of [symbol] 121.35. When the invoice is finally paid, the actual exchange rate may be lower than the estimated exchange rate (e.g. 0.8845). So the actual payment amount is less than the original invoice value amounting to an exchange gain. In this case the user may post a payment of [symbol] 114.94 to the account and create a new credit note for [symbol] 6.40 and post to the exchange difference nominal account.

Due to the above, managing part payments of foreign currency invoices in a non-multi-currency application is a very cumbersome task. In such a system, the gain/loss has to be maintained throughout each part payment.

This is an additional expense and apart from the requirement of the currency option, their business needs may not necessarily require the additional functionality that is offered by this Professional version of the software package.

In addition to this problem of how to cater for foreign currency transactions, using their accounting system, users manually pay the invoices with the exchange rate booked and then reconcile/allocate their transactions within the accounting system. A typical payment by a user of an accounting software package currently may take approximately 5 minutes to book, through recording in the accounts package and inputting the same details into an online banking system for payment purposes. Thus, there are two steps involved in a typical payment process, recording the payment in the accounts package, and inputting the same details into the online banking system.

For these reasons and others, there is a need for an improved system for making payments for foreign and domestic currency invoices using an accounting software package.

### SUMMARY

These and other problems are addressed by a computer-implemented method in the form of an application programming interface (API) which provides exchange rate booking for users using an online web service. An account may be set-up for each user who wishes to avail of the exchange rate from the system. Companies who trade with foreign suppliers for the purchase of goods or services may request payment in their local currency. When invoices are received from a foreign supplier the details of the invoice may be entered into the accounting software. When invoices are due for payment, the user may determine the total value of all invoices to be paid to each individual supplier. The user may then log on to an online service and book a specific exchange rate to transfer the monies due to the beneficiary account of the supplier. Once payment is received from the customer, the funds transfer to the beneficiary account may be executed. Finally, the funds transfer may be booked back into the accounting software package.

Local currency transactions may also be handled in a similar way to foreign currency transactions by applying an exchange rate of 1.

Accordingly the present teaching provides a computer-implemented method according to claim 1. Also provided is a global payment application in accordance with claim 46. Advantageous features are provided in the dependent claims.

These and other features of the present teaching may be better understood with reference to the following drawings.

### BRIEF DESCRIPTION OF THE DRAWINGS

The present teaching may now be described with reference to the accompanying drawings in which:

FIG. 1 is a block diagram showing the macro-architecture of the system according to the present teaching;

FIG. 2 is a flowchart showing the main steps of the computer-implemented method according to the present teaching;

FIG. 3 illustrates a user interface for setting up a new user account;

FIG. 4 illustrates a user interface for prompting a user to input their existing account details, login name and password;

FIG. 5 illustrates a user interface to allow the user to specify which accounting software package they are currently using;

FIG. 6 illustrates a user interface for the user to set-up a new bank account;

FIG. 7 illustrates a user interface showing the bank accounts set up for the user;

FIG. 8 illustrates a user interface showing all suppliers set-up in order to let the user select which suppliers may be enabled for use;

FIG. 9 illustrates a user interface for allowing the user to identify foreign currency suppliers amongst the list of suppliers;

FIG. 10 illustrates the main user interface of the application according to the present teaching;

FIG. 11 illustrates another user interface of the application for allowing the user to book payments for outstanding invoices;

FIG. 12 illustrates a user interface providing an additional field in the list of invoices for the user to specific the actual foreign currency value of the invoice;

FIG. 13 illustrates a user interface for allowing the user to select the exchange rate;

FIG. 14 illustrates a user interface of the application, listing all the invoices that were used to book the payment, and displaying a summary of all transactions posted to the accounting software package;

FIG. 15 is a block diagram illustrating an SSK skeleton for handling different accounting software packages and two SDKs for Accounting Software Packages 1 and 2;

FIG. 16 illustrates an exemplary computer system configured to perform the computer-implemented method according to the present teaching; and

FIG. 17 illustrates a simplified version of an exemplary computer system configured to perform the computer-implemented method according to the present teaching.

### DETAILED DESCRIPTION OF THE DRAWINGS

Exemplary arrangements of a computer-implemented method provided in accordance with the present teaching may be described hereinafter to assist with an understanding of the benefits of the present teaching. Such a method may be understood as being exemplary of the type of method that could be provided and is not intended to limit the present teaching to any one specific arrangement as modifications could be made to that described herein without departing from the scope of the present teaching.

The present teaching provides a computer-implemented method in the form of an integrated application programming interface (API) that enables users to query and book exchange rates and transfer payments to a supplier back to their supplier account in their accounting software package, thus automating a conspicuous amount of the manual process. The computer-implemented method may be implemented in the form of a global payments API that allows users from within their accounting package view live exchange rates and book payments. This is an integrated real-time approach and depending on whether invoices can be pulled in and out of the package, the payments may be reconciled in the package at the click of a button. As will be known to those skilled in the art, an API behaves like a browser whereby a user receives a synchronous result when a payment transfer is conducted. An API has advantages in terms of speed and responsiveness over other file transfer mechanisms such as FTP. An FTP upload is usually used when there is a large amount of information to be processed at the same time and servers need to be kept stable. FTP operates in an asynchronous mode. This means that when an FTP upload sends a file or a bunch of files the user program can do other tasks but until the server processes the request and sends a request back, the user has no idea if the request is being processed or not until he receives the result back from the server.

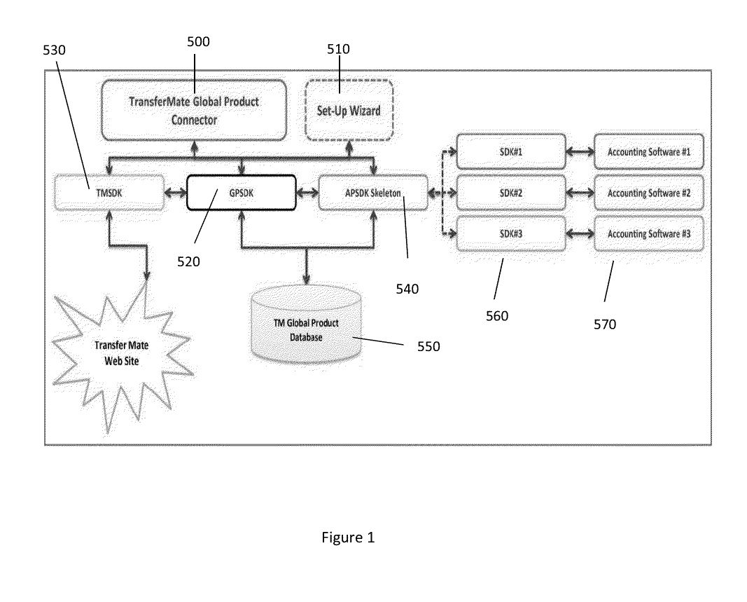

FIG. 1 is a block diagram showing the macro-architecture of the system according to the present teaching. This diagram is intended to give an overview of the different main components of the application.

Referring to FIG. 1, exemplary components of a system provided in accordance with the present teaching include a Global Product Connector 500, a setup wizard 510, a Global Product Connector Software Development Kit, SDK, (GPSDK) 520, an administrator SDK (TMSDK) 530, an Accounting Package SDK (APSDK) 540 and a TM Global Product Database 550. The Global Product Connector 500 is the front-end application, and includes main application interfaces. The setup wizard 510 is a wizard application for initialising and installing the application. A detailed explanation is provided later. The GPSDK 520 is the core application software development kit (SDK) and includes all application business rules, base interfaces and logics for dealing with the other SDKs. The administrative SDK (TMSDK) 530 is the SDK responsible for dealing with an administrative website. It handles all inbound and outbound communication with the on-line service.

The Accounting Package SDK (APSDK) 540 is the skeleton of the accounting package integration SDK. A detailed explanation thereof is provided later. The TM Global Product Database 550 is the data storage for the application. It contains all data used by the application. SDK#1 to #3 560 are the actual SDK related to each different accounting package. A detailed explanation thereof is provided later. Finally the architecture may include Accounting Software packages #1 to #3 570 installed on the user's computer.

The application may be developed using any one of a number of different programming languages or environments. One useful development environment is the Microsoft.NET C# programming language using the Microsoft.NET Framework v4.0. The integrated development environment used may be Microsoft Visual Studio 2010 Professional Edition. The database technology used by the application may be SQL 2008 Compact Edition. The application may exchange information with the administrative website using standard XML specifications. The application may use a number of 3rd party components to meet user expectation and Microsoft™ standards.

The present teaching may be usefully deployed as a desktop application that interfaces with one or more remote processing servers to provide the overall functionality of the system. The desktop application or user front end may typically be implemented in a Windows™ environment such that a user is provided with a Windows™ application for effecting the computer-implemented method. Using the application users may be able to load invoices from supported accounting packages and use exchange rates from a provided service to pay these invoices. An example of a supported accounting package is the SAGE program provided by The Sage Group—http://sage.com/ The application may also allow users to process the payments back into the accounting package.

Three different types of exchange rate facilities may be provided.

### 1. Spot Rate

At any given point in time users may be provided with the exchange rate on the day, which is called a ‘Spot Rate’. This spot rate may be inclusive of any margin applied to a user. The Spot Rate provided to the user may be only valid for a limited time period, for example 90 seconds. If the user is satisfied with the rate they can perform a booking and authorise the transfer of funds to be carried out on their behalf.

### 2. Forward Rate

The Spot Rates are subject to market conditions and fluctuate very frequently. As a result the Spot Rate may not be very attractive for some users who wish to have tighter control on their budgets and spending. For such users, an option may be provided to book the Spot Rate for future payments, which is called ‘Forward Rate’. This rate is based on a pre-agreed transaction value and also called a credit limit. The exchange rate remains constant and is valid only for a certain time period. The users may then utilise the lower exchange rate to pay beneficiaries until the expiry period. As transactions are carried out the current balance on the user's account is automatically updated. The Forward Rate becomes unavailable when either the expiry date has passed or the current balance becomes zero.

### 3. Order Rate

The concept of Order Rate is somewhat similar to Forward Rate. For high volume transactions even a small difference in exchange rate could lead to huge exchange gains or losses. The user may place a request for a specific rate with the online service. This is generally determined by the transactional value. The online service then sources the market for such a rate and when available indicates this to the user. When the ordered rate is available then the online service may send a notification to the user to inform them about the availability of the order. This rate may also only be valid for a specific time period.

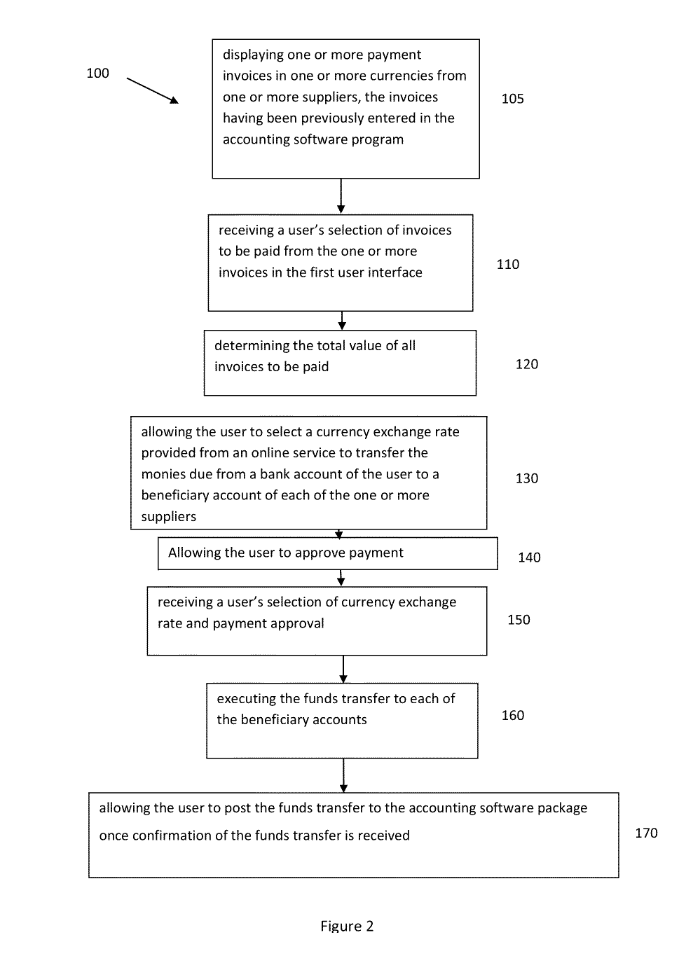

FIG. 2 is a flowchart illustrating the main steps of a computer-implemented method 100 according to an embodiment of the present teaching. The method 100 includes:

providing a user interface for displaying one or more payment invoices in one or more currencies from one or more suppliers, the invoices having been previously entered in an accounting software application 105; receiving a user's selection of invoices to be paid from the one or more invoices in the first user interface 110;
determining the total value of all invoices to be paid 120; allowing the user to select a currency exchange rate provided from an online service to transfer the monies due from a bank account of the user to a beneficiary account of each of the one or more suppliers 130; allowing the user to approve payments 140; receiving a user's selection of currency exchange rate and payment approval 150; executing the funds transfer to each of the beneficiary accounts 160; allowing the user to automatically post the funds transfer to the accounting software application once confirmation of the funds transfer is received 170; and automatically posting an exchange gain or loss in the accounting software application based on the funds transfer.

The displaying one or more payment invoices in one or more currencies from one or more suppliers, the invoices having been previously entered in an accounting software application 105; receiving a user's selection of invoices to be paid from the one or more invoices in the first user interface 110; determining the total value of all invoices to be paid 120; allowing the user to select a currency exchange rate provided from an online service to transfer the monies due from a bank account of the user to a beneficiary account of each of the one or more suppliers 130; allowing the user to approve payments 140; receiving a user's selection of currency exchange rate and payment approval 150; executing the funds transfer to each of the beneficiary accounts 160 may be performed in a booking payments screen of the user interface.

The allowing the user to automatically post the funds transfer to the accounting software application once confirmation of the funds transfer is received 170 may be performed in a post payments screen of the user interface. The API of the present teaching includes the functionality of pushing a payment file to the accounting software application, reconciling automatically, and thus automatically creating a currency gain or loss.

The application may be designed to integrate with a range of accounting software packages such as the aforementioned products provided by Sage.

Where the existing accounting software application does not provide any application plug-in architecture, the present teaching provides an architecture that includes a standalone Windows application configured to run alongside or in parallel with existing nominated accounting packages. The user may launch the application by either displaying a menu option within the accounting package that allows loading of an external executable file or could launch the application through a traditional mechanism such as double-clicking an application desktop shortcut icon or from the windows start program menu.

By providing such level of co-existence it is possible to provide a solution in accordance with the claimed teaching through a more integrated approach where such approach is facilitated by the existing accounting package and also as a stand-alone application where such integration is not possible.

Initialising the application may be performed using a wizard-style interface, which allows the user to choose various options and settings on the screen. Depending on the options selected by the user, the wizard may present appropriate screens to configure the application for each user's specific operating environment.

The application installation may be achieved by the user running a Windows set-up or installer package. The user may be advised of the availability of the application and specific instructions may be provided for users to download and install the set-up package. A single package may be used to install the application on the user's machine. The installation process assumes that users downloading and installing the application have administration or installing rights on the PC where the software is being installed.

After downloading the set-up package, users may install the application by running the set-up program with administration rights. After the installation is complete the user may then launch the application from the desktop shortcut or the program menus. The very first screen may request the user what language to use.

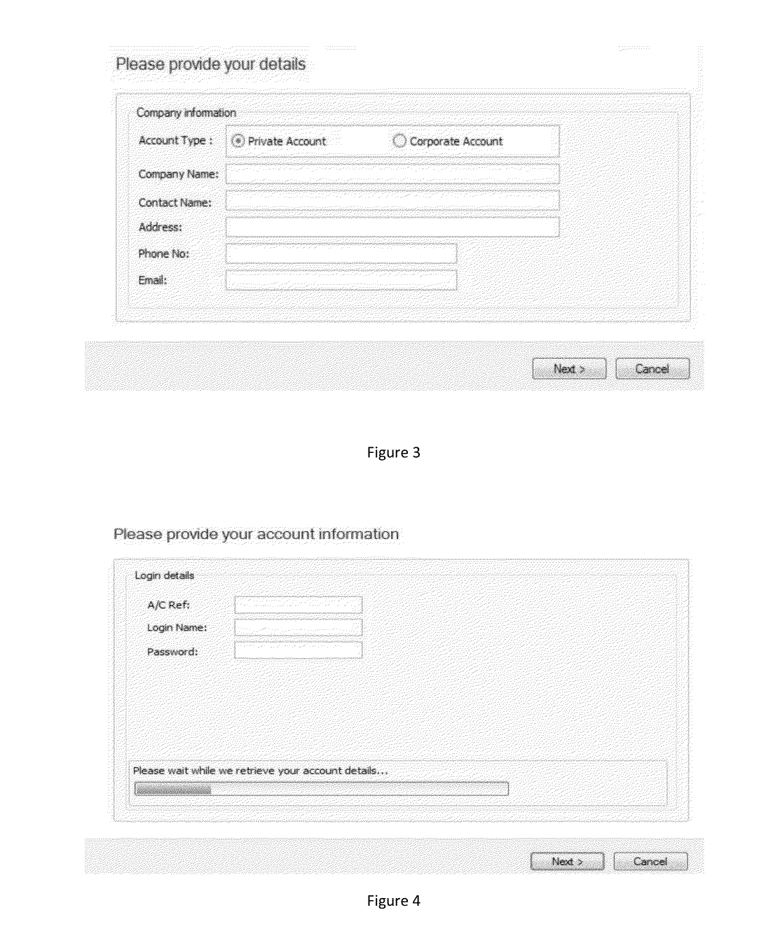

When the application is launched for the first time the user may be presented with the wizard-style interface which guides them through the necessary configuration and initialisation routines. The wizard may provide an option to the user to indicate if they are an existing account holder or if they would like to register for a new account. For new users, the wizard may prompt the user to specify general details to set-up the account. A user interface for entering these details is illustrated in FIG. 3. The application may allow for two types of accounts, one for private users and one for corporate users. Based on the type selected the user may have to complete relevant details. Different validations may also be performed based on the account type selected (i.e.: corporate accounts must specify a company name). More details on account types and user levels are provided later.

The application may perform basic validations on the entered data. Once the validation is passed, the application may send a request to an administrator website to create the account. The website may then set-up the account on the server and then return the new account number.

The new account set-up on the server may be initially set to inactive. Administration staff may then communicate with the user to continue the process of setting up the account on their server. This process may involve identifying the creditability of the company, authorising users on the online system and finally activating the account. Once the user's account is created and the new account number retrieved, the wizard may display the account number to the user and then close the application.

The application set-up process may not continue until the account is fully activated on the server. If the user attempts to run the application, the program may automatically check the status of the account and display a message on the screen to inform them that the account is not fully activated. Once the application determines that the account is active then the set-up may continue with the remaining configuration process. This process may be similar to the set-up of an existing account.

The first option on the wizard screen may be for the users to identify themselves as either a new user or existing user. For users who are already registered to use the application, the service may select the second option. The wizard may then prompt the user to input their existing account details, login name and password, as illustrated in the user interface of FIG. 4. The application may then communicate with the administrator website to validate the details provided. If the details are successfully validated then the application may download the accounts details, list of authorised users and the beneficiary accounts for use in subsequent screens.

A message may be displayed on the screen if the login process fails on the server or the account is invalid or inactive. If the account details are found on the server then they may be displayed to the user in the next screen. The set-up process may then guide the user with the remaining configuration options.

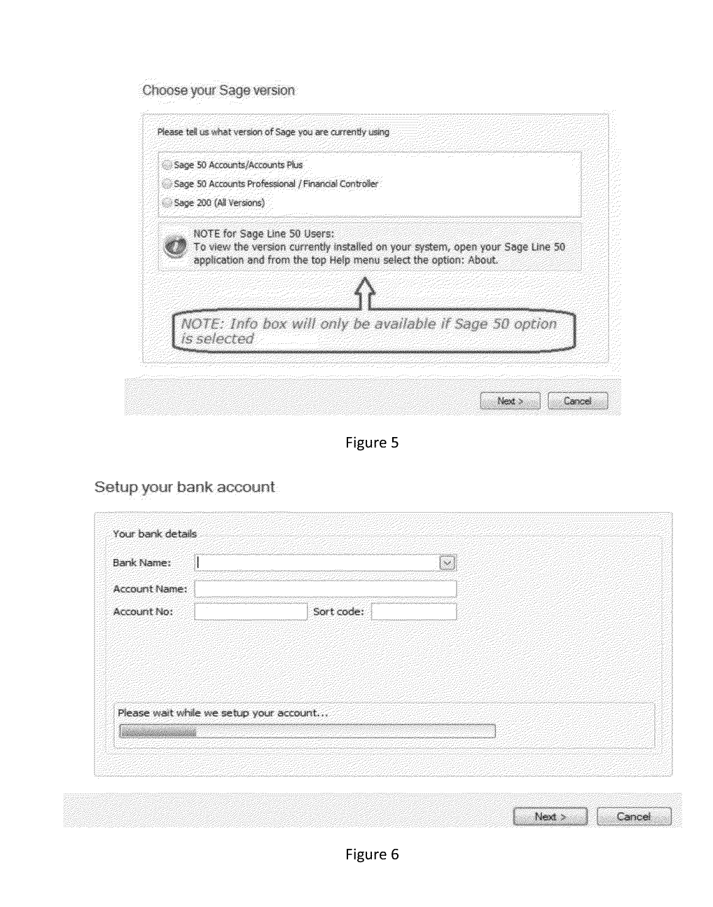

As part of the configuration process, the wizard may allow the user to configure the application with their existing accounting systems. Due to differences that may exist, such as between the versions of the accounting package used in relation to foreign currency, the wizard may present a user interface to allow the user to specify which version of the accounting package they are currently using. Such a user interface is illustrated in FIG. 5 and provides an easy interface for a user to change backend configuration parameters without expert knowledge.

Dependent on the version of the software deployed, the user may be presented with a login screen to specify their login details and select, from a drop down list, the data path for the company they wish to configure the application for.

If connection is not established to the existing accounting package using the details provided then a message may be displayed to the user illustrating the error message. If the details are correct, the wizard may continue with the configuration process depending upon the version of the accounting package previously selected by the user.

Once the user's details are authenticated, the wizard may then attempt to download the user's bank account details from the administrator website. If the bank accounts are not available for the user then the wizard may display a screen for the user to set-up a new bank account, as illustrated in FIG. 6.

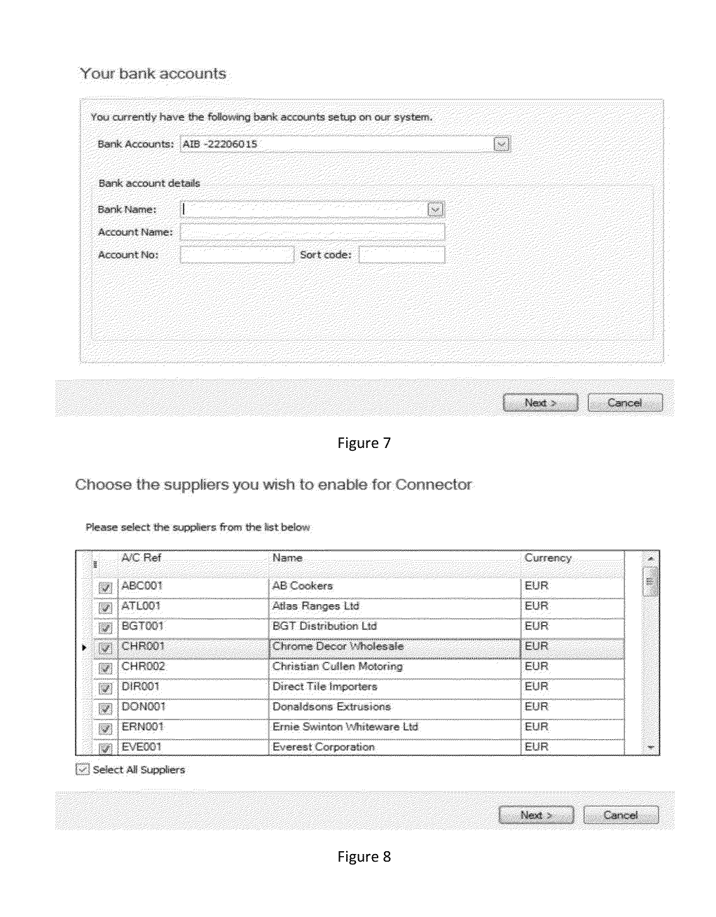

When the user attempts to move to the next screen, the wizard may send a request to the administrator website to set-up a bank account on the server for the user. If the account creation process fails, a message may be displayed on the screen. The user may not be able to continue unless the operation is successfully completed. FIG. 7 illustrates a user interface showing the bank accounts set up for the user.

Bank accounts that are already set up and available for the user may be displayed to the user on screen. The user may be able to change the details if they desire and in such a case the details may be sent to the administrator website for validation.

The application may request the administrator website to provide a list of all beneficiary accounts currently set up on the user's account. Available beneficiary accounts may be displayed on the screen. The user may also be provided with additional options to add, amend or delete a new beneficiary account as part of the set-up. A new screen may be provided to the user to enter the bank details to set-up the beneficiary account. Certain accounting packages, for example, provide users with an option to store bank account details for suppliers. The bank details are mandatory within certain accounting packages if the e-payment module is enabled.

The Add Beneficiary account screen may provide the user with a drop-down menu to select a specific supplier from the accounting package. When the supplier is selected, the application may interrogate the accounting package to verify if bank account details are available within the accounting package for the selected supplier. If the bank account information is available then the information may be automatically populated on the screen. When the user clicks on the submit option, the program may provide the details to the server to validate and create the beneficiary account for the user. The responsibility of validating the account details may rest with the server. Once the confirmation is received from the server, the program may display the same details on the wizard screen. The wizard may prompt the user if they wish to transfer the bank details back to the accounting package supplier file. If the user wishes to do so then the program may transfer the information back to the supplier account in the accounting package. The wizard may allow the user to synchronize the suppliers and beneficiaries in the accounting software application with the API and payment system of the present teaching. This may keep the details synchronised with the accounting package and the application server. In this way an application provided in accordance with the present teaching is configured to interrogate and use data already stored within an existing accounting package and then relay information back into that accounting package minimising double entry and ensuring that a single source of data is maintained. This ensures data integrity and reliability.

When funds are transferred to the beneficiary account by the application, it may be necessary to provide a reference for the payment. This reference generally is required to identify the source of payment received to reconcile the transactions at the beneficiary's end. The wizard may prompt the user to enter a default reference for all funds transfers executed by the application service on their behalf. The user may have the option to change the reference for each payment completed during the book payment process. In another aspect of the wizard setup, the user may be prompted to determine where they wish the currency loss/gain to be automatically recorded in the accounting software application. For example, the user may be prompted as to which folder the currency loss/gain is to be recorded in the accounting software application.

Regardless of the accounting software package selected, all suppliers set-up may be listed in order to let the user select which suppliers may be enabled for use. This is illustrated in FIG. 8. The suppliers selected here may be the only ones used when the user books a payment using the application.

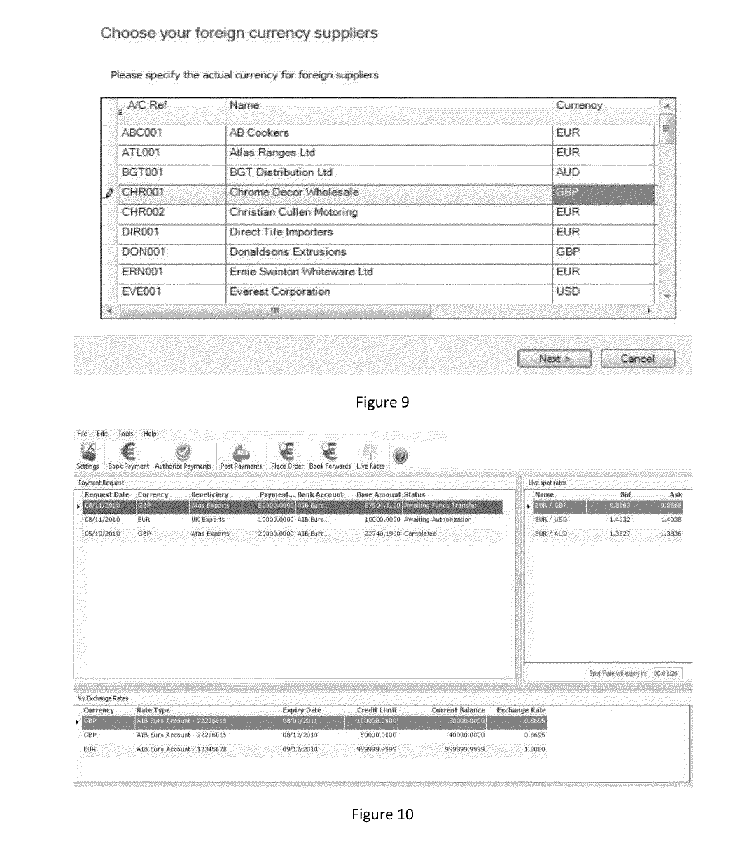

On the accounting software package selection screen, if the user has selected a version of an accounting package that does not have foreign currency functionality as standard, foreign currency suppliers may be stored as ordinary suppliers. To identify foreign currency suppliers, amongst the suppliers within such accounting packages, the wizard may display a screen for the user with the list of suppliers selected previously, as shown in FIG. 9. The user may then have to specify a non-euro currency for all foreign currency suppliers.

Since these versions of accounting packages do not handle exchange gain/loss automatically, the differences in exchange rates may need to be posted back as either invoices or credit notes and may be accompanied with a specific nominal code. The user may already have a nominal account designated for handling these transactions or may wish to use a generic nominal code such as Miscellaneous. The wizard may present the user the option to specify the nominal code that they wish to use to post these transactions. As mentioned above, the wizard may prompt the user to declare where they wish currency loss/gain to be automatically recorded in the accounting or third party application.

Finally, the wizard may allow the user to specify how the application should interpret the value of the foreign currency invoices posted to the suppliers account. Setting this preference may allow the application to decide to use either the exact value specified on the invoice as the foreign currency value or allow the user to specify the foreign currency value if the invoice was entered in the base currency. It is important to note that the application may take only foreign currency invoices with a full outstanding value into consideration. If an invoice has been partially allocated the application may not be able to deal with the outstanding value.

In versions of accounting packages that do handle foreign currency suppliers when a foreign currency supplier is initially entered in that package typically that supplier is created with the relevant foreign currency.

As mentioned above, Standard and Fast Payment Fee options may be handled as Cash Book Nominal Non-Taxable Payments. The user may decide at the time of posting payments in their accounting package which bank account to use for each payment. The transaction fee applied may be based on the payment option selected at the time of booking and may be based on the agreement between the application administrators and the user.

For each group of payments posted against the same bank account in the accounting package there may be one non-taxable payment representing the total amount for all transaction fees applied to such payments, regardless of whether they were processed as Standard or Fast payments. This is to keep to a minimum the amount of nominal transactions posted to the Bank Charge account.

After the configuration of the application is completed and the account is activated then the application may be ready for use. At this point the user may be able to finish the wizard and start the application, or choose to start the wizard again to set up another company (if more than one company exists on the system, otherwise the user may not be given any option but to complete the wizard). If the user decides to set up a new company, the wizard may go back to the accounting package company selection page as described above. In this way a single application may be stored and executable for a plurality of different companies, each company does not require a dedicated installation of the application.

When the application is launched by the user initially the logon dialog may be displayed to the user. The logon information provided may be the same login used by the user to connect to the accounting software package. The application may not provide any option to create or set up new users. Anybody with access to the accounting software package may be able to logon to the application. The process may attempt to connect to the accounting software package using the login details provided. Once the logon is successful, the user may be prompted to enter their application online service logon. This logon may be set-up by the application administrators on their server for all new users. Only users who are authorised to use accounting software package and also configured to access the online service may be able to access the application.

These two levels of authentication may provide adequate security to the application. If either the accounting software package login or application login fails then the user may not be allowed to access the application.

The application service may allow two types of accounts: a private account and a corporate account. The Private Account Type is intended for the use of single persons and allows the user full control of the system. The Corporate Account Type is intended for corporations and allows the creation of multiple users linked to the corporation with different levels. Available levels may be as follows:
Master User (Administrators): This level has access to all functionalities of the service; it can create new users, book and approve payments and view account summary.
Approver User: This level can book and approve payments and view account summary.
Data Entry User: This level can only book payments and view account summary.

User level information may be downloaded by the application at the time user credentials are authenticated and may mirror the above-mentioned permission on the application interface. Note that the creation of corporate users may not be conducted through the application but may be performed using the administrator website.

Once authentication is successfully completed the main user interface of the application may be displayed to the user. FIG. 10 illustrates the main user interface. The user may be able to access all or limited functionality from the main user interface based on their access level.

This main user interface may also allow the user to manage the application settings, book payments, authorise payments (if the currently logged user level permits it) post payments to the accounting package, place a request for a rate, place a request for a forward rate and view live rates etc. These options may be provided by means of icons at the top of the screen. Where a user access levels deny some aspect of functionality the related icons may be hidden from view.

The main user interface may incorporate various sections to display information at a glance. The top section may display all the requests for payment made on the account and the current status of the current request. The user may be able to view the current ‘Live Spot Rates’ available to them on a separate section of the screen. If the user has Forward Rates available to them, these may be displayed at the bottom of the user interface in a separate section. All the information in this main user interface may automatically refresh at a pre-determined time interval providing up to date information to the user. The above-described layout may be for Approvers and Administrator user levels.

The initial configuration of the application may be performed by using a wizard-style interface as described above. Once the initial configuration and set-up is complete, the main user interface may provide a settings button for users to modify any settings and options used within the application.

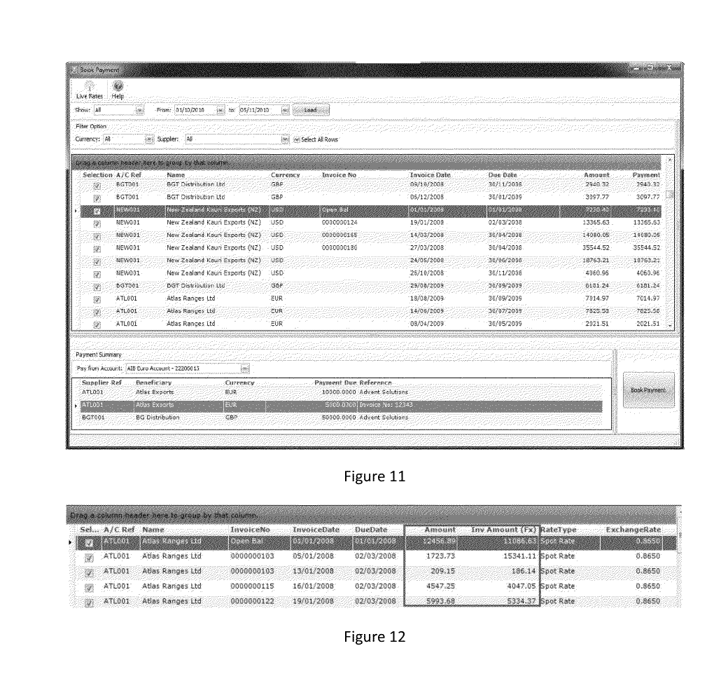

When the user is ready to make payments, they may be able to access the book payments screen by clicking on the ‘Book Payment’ option on the main toolbar. This may bring up another screen, illustrated in FIG. 11, which may allow the user to book payments for outstanding invoices. Typically, a user may wish to pay a supplier for a range of invoices. The user may wish to pay multiple suppliers if the rate is favourable to them.

The user may be able to list all the outstanding invoices based on a date range. This may list the outstanding invoices across all suppliers or specific suppliers set by the user. The information may be grouped based on supplier. The user may also have the option to filter the invoices for a specified currency or for a specific supplier. From the list of invoices displayed the user may be able to select the invoices they wish to pay. The system may read the country of origin of each of the suppliers and alert the user if one or more of the invoices are foreign currency invoices.

To start the booking process the user may first select all the invoices they wish to pay. Based on the invoices selected, the application may build and display a summary of beneficiary accounts related to the invoices selected. If the invoices selected span across multiple suppliers then the screen may display all the beneficiaries. The total payment amount required may be automatically calculated based on the amount due on the invoices.

To complete the booking process the user may have to select the bank account they wish to make the payment from, and the type of payment to be submitted to the program. By default all payments may be submitted as Standard payments unless the user explicitly checks the option for Fast payment (see bottom grid on previous image), and then clicks on the ‘Book Payment’ option. The program may send the payment request to the server and wait for confirmation. Once the confirmation is received, the application may react based on the level of the user currently logged.

If the user has data entry access, it may be brought back to the main user interface of the application and view the updated payment request summary. All payments that have been just booked may have a status of ‘Awaiting Authorization’; otherwise the user may be brought to the Approve Payment screen described in the next section.

Depending upon the particular user's initial selection, a foreign currency invoice may be entered in the accounting package with the invoice value representing the actual foreign currency value outstanding or a value converted to the base currency using an estimated exchange rate.

As part of the set-up the user may specify this invoice value type, which may be used by the application to determine if the invoice value is foreign currency value or a converted value. If the value is converted, then the booking screen may provide an additional field in the list for the user to specific the actual foreign currency value of the invoice, as illustrated in FIG. 12. This may be the value used by the application to use for booking payment.

The Approve Booked Payment screen may display all payments ‘Awaiting Authorisation’ and allow the user to apply the same filters provided on the web site. For each pending payment a check box may be available to the user in order to select which payments to approve. Only payments for the same currency may be approved at the same time. The screen may also display the live Spot Rates available to them, which may be refreshed at a particular interval, for example every 90 seconds. If the user has Forward Rates available to them this may also be displayed, providing them the option to use the Forward Rate if they wish.

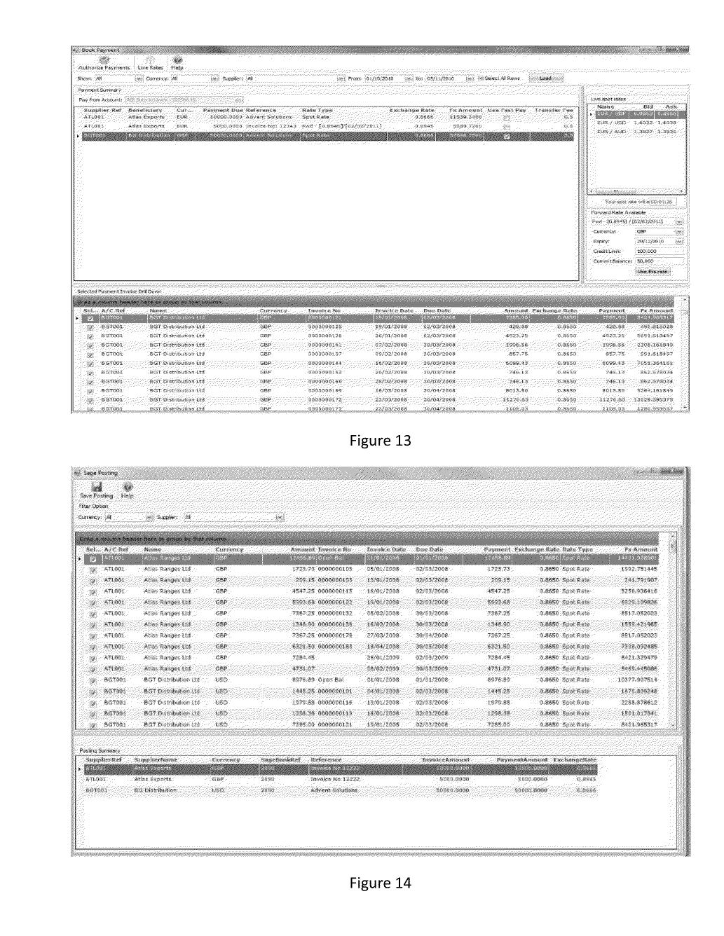

Referring to FIG. 13, the application may automatically use the current Spot Rate available and calculate the amount needed to be transferred. This value may be automatically refreshed every 90 seconds providing the user with the actual transfer amount. If there is a transfer fee applicable on the account, the program may also display the relevant amount. If the Forward Rate is available to the user, then the user may be able to use it by selecting the Forward Rate from the dropdown on the Payment Summary screen. For each beneficiary account displayed on the list, the payment reference may also be automatically populated. The user may have the option to modify this payment reference for any payment before it is sent to the server.

The bottom section of the screen may list all invoices that make up the currently selected payment to give the user additional details. Once the user has selected the payments to approve it may click on the ‘Approve Payments’ button. The program may first verify if any Spot Rate used is still valid. If not, then a message may be displayed on screen to inform the user that the rate used is no longer available. The program may also make sure that any forward rate applied is still valid and that sufficient credit is available to book the payment. If all validations are successfully completed the program may then send the authorised payment details to the server and wait for confirmation. Once the confirmation is received, a message may be displayed with instructions of how and where to make the funds transfer.

If the bank used for the payment has been set-up for direct debit then the following message may appear to the user: “Payment may be taken by direct debit today. Please allow 3 days for Direct Debit payments.” The same message may also be displayed in the status message on the account summary.

As part of the book payments option the information may only be sent as a request for transfer to the server. The actual payments to the beneficiary may not be carried out until the user transfers the funds to the account specified for payment. Once payments are received into the account, the application may then execute the funds transfer to the specified beneficiary. The user may then be able to post transactions to the accounting software package after the confirmation of the funds transfer is received from the application. This may eliminate the need to perform any reversal of payment in case the funds transfer did not materialise. To post payments to the accounting software package the user may be able to highlight the payment on the main application screen and use the ‘Post Payment’ option.

This may display a screen, as illustrated in FIG. 14, listing all the invoices that were used to book the payment. The posting summary section may display the summary of all transactions that may be posted to the accounting software package. The posting may be for the total invoice amount paid for each supplier account and the currency and exchange rate used to make the payment. All the invoices related to the payment may be automatically allocated and an exchange gain or loss may be posted to the correct Nominal.

Transaction fees applied for Standard or Fast payment options may be grouped based on the Bank Accounts selected for each payment and posted as Cash Book Non-Taxable Payments to the relevant Bank Account and to the default or multiple Nominal accounts within the accounting package.

If the user has Forward Rates available to them then they may be displayed in the book payment screen. The user may be able to use any Forward Rate available by clicking on the ‘Use this rate’ option displayed against the specific Forward Rate. The program may then automatically set all the selected invoices to use the Forward Rate and automatically set the payment amount to be the full amount on the invoice. For each individual invoice the rate type may be set to the selected forward rate and the amount due may be automatically calculated.

The application may work on an invoice-by-invoice basis calculating the total payable amount using the exchange rate and deducting this new amount from the remaining balance on the account. If the amount required to pay all invoices is more than the available balance on the Forward Rate, then the process may use the current Spot Rate and warn the user at the end of the process. If the user wishes to use a different Forward Rate for a specific list of invoices they may be able to choose the rate type on the individual invoice line on the list.

Irrespective of which rate is used the program may automatically update the payment summary section with the final payment amount required using the correct exchange rate. The main screen may allow the user to place a request for a particular rate. This option may only send a request to the application service. The Administrator may then communicate with the user when the rate is available.

To request a Forward Rate the user may be able to use the main screen to invoke the option to enter the request details. This option may only send a request to the application service and the Administrator may communicate with the user when the rate is available. The rate may be set-up as a Forward Rate on the server and the application may download the rate and make it available to book a payment.

It will be appreciated that different accounting packages are provided with different underlying architectures which may be vastly different, starting initially with the data storage technologies used by the two applications. For example certain packages use a proprietary file based data storage while in other applications data storage is implemented using Microsoft SQL technology. Furthermore, the frameworks provided may also be substantially different.

However, both are accounting packages and the integration implemented by the application software according to the present teaching requires standard accounting facilities, such as the posting of Purchase Payments, or retrieval of outstanding Purchase Invoices.

Therefore the concepts for the integration to work are common to each of the accounting packages products; the major difference resides on the technologies used, but this can be provided in a manner that is transparent to the end user through use of dedicated drop down menus and the like as part of the installation process. In this way an application provided in accordance with the present teaching may be implemented as an interface to one or more different applications.

For this reason the application interfaces may be exactly the same regardless of the accounting package implemented by users. In this way the present teaching provides an intuitive interface that may be easily deployed across multiple packages without specific training requirements.

The application may be designed to be a multi-language application. In order to achieve this, all labels and messages may be stored in a database and retrieved at run time based on the language selected during installation.

In order to handle multi-language capabilities a new layer of software may be designed. This layer may be responsible for populating all labels and messages used across the application's interfaces. Basically, each user interface component (i.e.: labels, column names, screen titles) may be coded as well as each user message. Such codes may also be stored in a database along with the actual value for each available language.

When the application's screens are loaded at run time, the base classes responsible for managing interfaces may retrieve the actual values from the database based on the label codes and language (selected during installation) and may populate accordingly all labels and messages on the screen. In some cases the application may display messages coming directly from the server (i.e.: error messages), such messages should be in the right language selected. This may be implemented in two different ways. The user set-up on the administrator website may have a default language, and each message sent across may be in such a language. Alternatively, every time the application submits a request to the administrator website, the actual language code may be part of the parameter sent. The administrator website may then return the message based on such parameter.

A list of all labels and messages used across the application may be provided by the Administrators. Translated values may be inserted into the database. The application may be designed to integrate with multiple accounting applications. The application may not integrate directly with the accounting package. A middle layer of software may be designed and may be responsible for integrating with the application on one side, and with the relevant accounting software on the other side.

Since different accounting packages have different integration architectures, it may not be possible to design a single SDK to handle all of them. Therefore, an SDK may be implemented for each accounting package that needs to be integrated with the application. In order to do so in a maintainable manner and in a way that meets the requirement of a single release of the application, a template SDK may be developed with which the application may interface.

The actual SDK may then be implemented according to the template SDK on one side; on the other side the required technologies may be used in order to integrate all needed functionalities with the given accounting package.

Following this architecture, the application may not need to know anything about the actual integration with the accounting package as it may only interface with the template SDK which may provide all the necessary functionality. This may be determined at the time of installation and may be dictated by the accounting software installed on the user side.

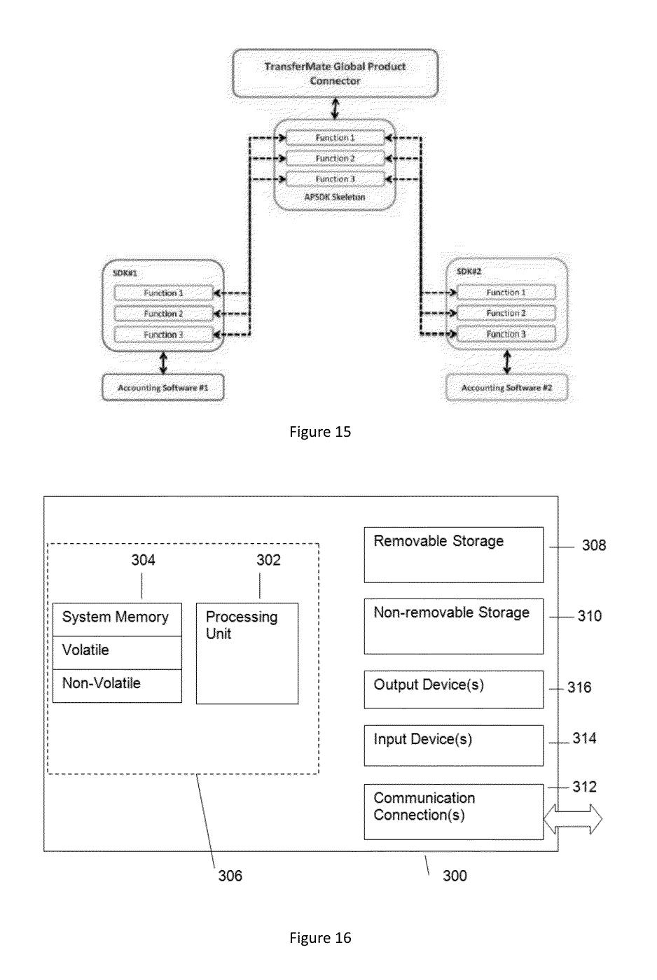

In order to handle different accounting software packages, an SDK skeleton may be designed. This skeleton may support all functionalities needed by the application but without any actual implementation. For each accounting package an SDK may be implemented following the skeleton known to the application. FIG. 15 is a block diagram illustrating an SSK skeleton and two SDKs for Accounting Software Packages 1 and 2.

During the installation process the actual accounting package may be defined either automatically or by the user so that when the application runs, the correct SDK is loaded. Each time the application needs information from the accounting package it may call the relevant functionality defined on the skeleton.

Since the actual SDK integration with the accounting package is implemented based on the skeleton and this actual SDK is loaded at run time, the functionality called by the application may be executed by the actual required SDK. This may, of course, know exactly what to do as it is implemented specifically for the accounting software package running on the user side.

To give a better understanding of the architecture, a simple example is provided below. The application may need to be able to retrieve a number of details of outstanding invoices for a given supplier from the accounting package. Therefore a function can be implemented on the skeleton that performs such an operation based on a parameter (i.e.: the supplier account reference) and returns a set of records with a number of fields known to SagePay Foreign Exchange (i.e.: Invoice Number, Invoice Date).

The SDK skeleton may implement a dummy function with the following signature:

### Function Name: GetOutstandingInvoices( )

Parameter: SupplierReference (string)

### Return: InvoiceDataTable

The code for the SDK may be something like:

### Public Function GetOutstandinglnvoices(string SupplierRef) as InvoiceDataTable

No actual code is implemented in the skeleton, only the function signature. Now, assume that we are integrating with two different accounting packages, one that provides a complex SDK, the other a simpler integration which means we may have to perform more actions to gather the details we need.

Assuming that Accounting Package #1 has a specific function on its SDK to perform the operation required (i.e.: retrieve outstanding invoices for a given supplier), while Accounting Package #2 only allows connection with its database and the outstanding invoices have to be manually retrieved. Two SDKs may need to be designed, one for each accounting package.

On SDK#1, the code that actually implements the function may be something like:

Public Function GetOustandingInvoices(string supplierRef) as
InvoiceDataTable
//create a data table to populate with the details returned by SDK1
Dim outstandingInvoicesFromSDK as DataTable
//create an instance of SDK#1 provided by the accounting software vendor
Dim sdk1 as new SDK1
//call the vendor function to retrieve o|s invoices for a given supplier
outstandingInvoicesFromSDK =
sdk1.GetOutstandingInvoices(supplierRef)
//create an invoice data table as known to SagePay
Dim oustandingInvoices As InvoiceDataTable
//format the table returned by SDK1 to a datatable known to SagePay
oustandingInvoices =
FormatTableForSagePay(outstandingInvoicesFromSDK)
//now we can return the filled data table as known by SagePay
Return oustandingInvoices
End Function

On SDK#2, it may be more complex, like:

Public Function GetOustandingInvoices(string supplierRef) as
InvoiceDataTable
//create an invoice data table as known to SagePay that we may populate
//with the details retrieved from the database
Dim oustandingInvoices As InvoiceDataTable
//enquiry the database to get required data
//NOTE: the actual function would be more complex and based on the
//database technology used
oustandingInvoices = GetOutstandingInvoiceFromDatabase(supplierRef)
//now we can return the filled data table as known by SagePay
Return oustandingInvoices
End Function

However, the part of code implemented within the application may not change, as it may use the signature defined on the skeleton, and may be something like:

[...]
//create an invoice table to populate with results
Dim oustandingInvoices As InvoiceDataTable
//create an object based on the SDK skeleton
Dim accountingIntegration as SDKSkeleton
//load the actual SDK based on the accounting software on user's
computer accountingIntegration = LoadSDK( )
//now call the function we need for supplier SUPP01
oustandingInvoices =
accountingIntegration.GetOutstandingInvoices(“SUPP01”)
[...]

The code may not change as the skeleton which knows about the function we need is used; however the actual function called may be on SDK#1 or SDK#2 based on the actual software installed on the user.

The Accounting Package SDK may define all functionalities needed by the application in order to function properly. To each functionality may correspond a function, method or property signature.

A complete list of functionalities (and relevant signatures) may be provided; such list may then be used as a reference when initialising the process for the implementation of other accounting packages.

As explained previously, an SDK following the skeleton may need to be designed for each accounting package that requires integration. Since each accounting software is built with different technologies and may provide its own way of integration, a detailed description thereof is nor provided herein.

The Wizard interface may also allow the user to select from a range of accounting packages implemented by the application. The Wizard application may attempt to automatically recognise the accounting package installed on the user's PC. If a successful link is made only the Accounting Package connection details page may be displayed. Otherwise a Wizard page may be displayed, allowing the user to select the correct accounting package from the drop down list.

The accounting software packages listed and the relevant description may be generated at run-time, based on all SDKs currently available on the set-up package. A note-box may inform the user on how to find what software they have installed in case they cannot locate the correct one. Another note-box may advise the user to contact a support desk in case they cannot locate the accounting software among the list presented. Once the accounting package has been selected (or if it was successfully discovered by the Wizard application), the user may be requested to specify the connection details.

Since the set-up of connection details may vary with different accounting packages, the interface described above may not actually be part of the Wizard application, but rather part of the SDK of the selected accounting package. The screen described above is therefore just a sample screen that may be different for every application integrated with the application according to the present teaching. The relevant Accounting Package Icon may also be shown.

The application functionality may depend on the services provided by the online service. The application may be designed to communicate with the online service to retrieve and post the information required by the application to function properly. The following sections may give more details on the technology and standards used for the communications.

The application according to the present teaching, using the online system in the background, may take into consideration the structure, steps and logic existing within the online system. Minimal changes and amendments may be required in the way new user accounts are being created, the way users log in, add bank accounts & beneficiary details, book rates and make payments.

This section describes, in technical terms, the technology that may be involved in the communications between the application and the web-based system.
All communications may be made via standard HttpRequests/HttpResponse.
No session may be kept open between the application and the web site as the application may need to communicate only in certain occasions and for limited periods of time.
Each time a request is sent to the web site, credentials and sha256 signatures may be sent for authentication.
Methods supported by the requests may be the standard Http protocol methods: GET, POST, PUT and DELETE.
GET methods may be directed to the specific URLs. Needed parameters may be included on the URL (query string), and may expect a response in XML format.
POST/PUT/DELETE methods may be directed to specific URLs. Needed parameters may be included on the URL (query string), and may expect a response in XML format.
Wherever applicable, common Http error codes may be used (i.e.: 400—Bad Request, 401—Unauthorised and so on) additional messages can apply wherever necessary.
Request redirections may be supported.

As described above, the application may operate under a windows operating system environment. The present teaching provides a global payments API that allows users from within their accounting software package view live exchange rates and book payments. This is an integrated real-time approach and depending on whether invoices can be pulled in and out of the package, the application may reconcile the payments in the package at the click of a button.

This saves the user a mountain of double entry. A typical payment may take 5 minutes to book through recording in the accounts package and inputting the same details into the user's online banking system. The computer implemented method according to the present teaching may reduce this time significantly.

Using the system, all of the user's beneficiaries can be viewed along with the currency paid to them on one screen. The amounts to pay each user are simply entered and then the user can click for live rates. For example, the user may have a batch of 20 payments, but only one operation is needed by the application to process the 20 payments.

The online system allows multiple payments to be made to multiple beneficiaries in multiple currencies in one click of a mouse. Processing time may be cut dramatically and a better foreign exchange rate may be obtained by combining multiple transactions. In addition to this, a bank verifier may automatically check that the beneficiary bank details entered are correct. This account verification will reduce bounce backs, and save time tracking payments with the bank.

In one aspect of the present teaching once the payments have been booked the system may be configured to auto post the transaction details back into the accounting package based on a transfer completion status being received. In such an arrangement, the transfer, once booked, awaits funds and shows ‘awaiting funds status’ within the system. As soon as the payment agency which is in communication with the system of the present teaching records that the funds have been received and paid, it changes the status to ‘paid’. This change in status can trigger an auto post/reconciliation process to the underlying accountancy package.

Using the system, live exchange rates may be updated every 3 seconds for the user to view and book. This may be in contrast to a bank's online payment system that provides an indicative rate. For example, using a bank's online payment system, the day funds are taken another rate may be applied.

In another aspect of the present teaching a transaction monitoring module is provided to interface with an accounting package already used within a networked environment. In instances where the user has not activated a live feed from the remote online service to select an appropriate currency for a transaction but rather is using their existing payment provider, the transaction monitoring module is configured to capture:

Currency paid and amount

Currency used to pay/base currency and amount.

This data set can then be packaged and sent securely over a network communication protocol to a remote server where it is used to populate a message back to the accounts system to alert how much the client would have saved, having auto compared with the live feed option heretofore described. Such an arrangement also allows recordal of the margins applied by third party bank on all transactions. This data may be used to populate a screen, a message or a pop-up to see savings on all transactions/clients. It will be appreciated that this functionality can be used to enter a foreign invoice amount to determine how much cheaper the payment could have been made for by using the live feed exchange option. The transaction monitoring module may be used for both historic and current comparison. For example, a foreign currency invoice previously entered using an existing payment provider can be checked and compared with the live feed exchange option heretofore described. Such comparison may show a saving the client could have made had he/she selected the live feed exchange option in the API of the present teaching at the time of the transaction. The transaction monitoring module may also be used to compare foreign currency invoice payments at the time of payment using both an existing payment provider and the live feed exchange option of the API of the present teaching. Payments may be entered as normal using an existing payment provider but once entered the API reads the currency bought, sold and the amounts involved. This data may be used to populate a screen, a message or a pop-up in the accounting software application to notify how much the client could have saved had he/she selected the live feed exchange option in the API. Thus, if a third party integrates the API of the present teaching into their software, the API can compare the exchange rates or amount of a currency paid/bought with live feed exchange option and provide a notification of what they could have saved had they used the API. In another aspect, once a user has registered to use the API, it can be identified that that user has registered. Once it is identified that the user has registered, the API may be configured to stop the popup or messaging to the client. Otherwise the client would sign up but continue to get messaging to say they could obtain savings using the API when they are already using it.

In another aspect, summary information relating to the potential savings from a comparison as described above may be sent to a partner. The partner may integrate the API of the present teaching into their software. The API may not only alert the partner what the client could have saved but in addition may also share this data with the partner. For example, the data may include at least one of client name, client ID, date, currency bought, currency sold, amount bought, margin paid to bank/provider, and potential partner revenue. The data may not include the client name. For example, the data may contain the client ID instead of the client name. In this manner, sensitive client information may not be shared with third parties.

FIG. 16 illustrates an exemplary computer system 300 configured to perform the computer-implemented method according to the present teaching. In one implementation, the computer system 300 typically includes at least one processing unit 302 and memory 304. Depending upon the exact configuration and type of the computer system 300, the memory 304 may be volatile (e.g., RAM), non-volatile (e.g., ROM and flash memory), or some combination of both. The most basic configuration of the computer system 300 need include only the processing unit 302 and the memory 304 as indicated by the dashed line 306.

The computer system 300 may further include additional devices for memory storage or retrieval. These devices may be removable storage devices 308 or non-removable storage devices 310, for example, memory cards, magnetic disk drives, magnetic tape drives, and optical drives for memory storage and retrieval on magnetic and optical media. Storage media may include volatile and non-volatile media, both removable and non-removable, and may be provided in any of a number of configurations, for example, RAM, ROM, EEPROM, flash memory, CD-ROM, DVD, or other optical storage medium, magnetic cassettes, magnetic tape, magnetic disk, or other magnetic storage device, or any other memory technology or medium that can be used to store data and can be accessed by the processing unit 302. Software code relating to the computed-implemented method of the present teaching may be stored on the storage device using any method or technology for storage of data, for example, computer readable instructions, data structures, and program modules.

Referring to FIG. 16, the computer system 300 may also have one or more communication interfaces 312 that allow the system 300 to communicate with other devices. The communication interface 312 may be connected with a network. The network may be a local area network (LAN), a wide area network (WAN), a telephony network, a cable network, an optical network, the Internet, a direct wired connection, a wireless network, e.g., radio frequency, infrared, microwave, or acoustic, or other networks enabling the transfer of data between devices. Data is generally transmitted to and from the communication interface 312 over the network via a modulated data signal, e.g., a carrier wave or other transport medium. A modulated data signal is an electromagnetic signal with characteristics that can be set or changed in such a manner as to encode data within the signal.

The computer system 300 may further have a variety of input devices 314 and output devices 316. Exemplary input devices 314 may include a keyboard, a mouse, a tablet, and/or a touch screen device. Exemplary output devices 616 may include a video display, audio, speakers, and/or a printer. Such input devices 314 and output devices 316 may be integrated with the computer system 300 or they may be connected to the computer system 300 via wires or wirelessly, e.g., via IEEE 802.11 or Bluetooth protocol. These integrated or peripheral input and output devices are generally well known and are not further discussed herein. Other functions, for example, handling network communication transactions, may be performed by an operating system in the non-volatile memory 304 of the computer system 300.

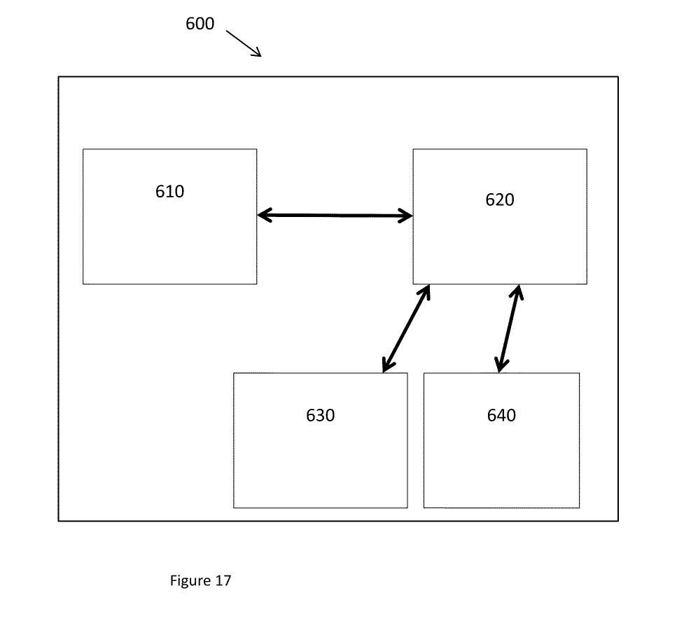

FIG. 17 illustrates a simplified version of an exemplary computer system 600 configured to perform the computer-implemented method according to the present teaching. Referring to FIG. 17, the system includes an accounting software application 610 for entering payment invoices in one or more currencies from one or more suppliers; and a global payment application 620 for interfacing with the accounting software application 610, an online service 630 providing an exchange rate to the global payment application 620, and an online banking service 640. The global payment application 620 may be configured to perform the computer-implemented method according to the present teaching as described above. The global payment application 620 may be configured to interface between the accounting software application 610 and each of the online service 630 and the online banking service 640. The global payment application 620 may be configured such that data originating from and stored in the accounting software application 610 is routed through the global payment application 620 to the online banking service 640.

The words comprises/comprising when used in this specification are to specify the presence of stated features, integers, steps or components but does not preclude the presence or addition of one or more other features, integers, steps, components or groups thereof.

While the present invention has been described with reference to some exemplary arrangements it may be understood that it is not intended to limit the teaching of the present invention to such arrangements as modifications can be made without departing from the spirit and scope of the present invention. In this way it may be understood that the invention is to be limited only insofar as is deemed necessary in the light of the appended claims.

What is claimed:

1. A computer-implemented method in the form of an integrated application programming interface (API) for booking payments entered in an accounting software application, comprising:
providing a user interface for:
displaying one or more payment invoices in one or more currencies from one or more suppliers, the invoices having been previously entered in the accounting software application;
receiving a user's selection of invoices to be paid from the one or more invoices in the user interface;
determining the total value of all invoices to be paid;
allowing the user to select a currency exchange rate provided from an online service to transfer the monies due from a bank account of the user to a beneficiary account of each of the one or more suppliers;
allowing the user to approve payments;
receiving a user's selection of currency exchange rate and payment approval;
executing the funds transfer to each of the beneficiary accounts; and
allowing the user to automatically post the funds transfer to the accounting software application once confirmation of the funds transfer is received; and
automatically posting an exchange gain or loss in the accounting software application based on the funds transfer.

2. The method of claim 1, wherein the displaying the one or more invoices comprises displaying an invoice value representing the actual foreign currency value.

3. The method of claim 1, wherein the displaying the one or more invoices comprises displaying a value converted to the base currency using an estimated exchange rate.

4. The method of claim 1, wherein the displaying the one or more invoices comprises listing all the outstanding invoices based on a date range.

5. The method of claim 1, wherein the displaying the one or more invoices comprises listing the outstanding invoices across all suppliers.

6. The method of claim 5, comprising reading the country of origin of each of the suppliers and alerting the user if one or more of the invoices are foreign currency invoices.

7. The method of claim 5, wherein the displaying the one or more invoices comprises grouping the outstanding invoices by supplier.

8. The method of claim 1, wherein the displaying the one or more invoices comprises filtering the outstanding invoices by currency.

9. The method of claim 5, wherein the displaying the one or more invoices comprises filtering the outstanding invoices by supplier.

10. The method of claim 1, wherein the receiving a user's selection of invoices to be paid from the one or more invoices in the first user interface comprises building and displaying a summary of beneficiary accounts related to the invoices selected.

11. The method of claim 10, comprising receiving a user's selection of bank account the payment is to be made from.

12. The method of claim 10, comprising receiving a user's selection of the type of payment.

13. The method of claim 12, wherein the type of payment is standard payment or fast payment.

14. The method of claim 13, wherein standard payment is processed within 3 days.

15. The method of claim 13, wherein fast payment is processed within one day.

16. The method of claim 13, comprising applying a transaction fee.

17. The method of claim 16, wherein the transaction fee is the same for local and foreign currency payments.

18. The method of claim 1, wherein the allowing the user to select a currency exchange rate comprises providing a rate facility.

19. The method of claim 18, wherein the rate facility comprises:
a spot rate which is valid for a limited time period;
a forward rate which is valid for payments in the future up to an expiry time; or an order rate which comprises an exchange rate requested by the user and determined by the transactional value of the invoices.

20. The method of claim 19, wherein the spot rate is available for about 90 seconds.

21. The method of claim 19, wherein the forward rate becomes unavailable when either the expiry date has passed or the current balance of the user's bank account becomes zero.

22. The method of claim 19, comprising sourcing the market for the order rate and when available informing the user.

23. The method of claim 22, wherein the order rate is valid for a specific time period.

24. The method of claim 1, wherein local currency transactions are handled by applying an exchange rate of 1.

25. The method of claim 1, comprising processing the invoices on an invoice-by-invoice basis calculating the total payable value using the exchange rate.

26. The method of claim 19, comprising, if the amount required to pay all invoices using the forward rate is greater than the available balance on the user's bank account, using the current spot rate and warning the user at the end of the process.

27. The method of claim 19, comprising using a different forward rate for specific invoices of the one or more invoices to be paid.

28. The method of claim 1, wherein the funds transfer is not executed until the user transfers funds to the user's bank account.

29. The method of claim 1, wherein the allowing the user to post the funds transfer to the accounting software application once confirmation of the funds transfer is received comprises displaying a screen listing all the invoices that were used to book the payment.

30. The method of claim 29, comprising displaying a summary of all transactions to be posted to the accounting software application.

31. The method of claim 29, comprising displaying the total invoice amount paid for each supplier account and the currency and exchange rate used to make the payment.

32. The method of claim 1, being implemented in a windows desktop application.

33. The method of claim 1, wherein the displaying one or more payment invoices in one or more currencies from one or more suppliers, the invoices having been previously entered in the accounting software application; receiving a user's selection of invoices to be paid from the one or more invoices in the user interface; determining the total value of all invoices to be paid; allowing the user to select a currency exchange rate provided from an online service to transfer the monies due from a bank account of the user to a beneficiary account of each of the one or more suppliers; allowing the user to approve payments; receiving a user's selection of currency exchange rate and payment approval; and executing the funds transfer to each of the beneficiary accounts is performed in a booking payments screen of the user interface.

34. The method of claim 1, wherein the allowing the user to automatically post the funds transfer to the accounting software application once confirmation of the funds transfer is received is performed in a post payments screen of the user interface.

35. The method of claim 1, being configured to be integrated with multiple accounting software applications.

36. The method of claim 35, comprising providing a middle layer of software for integrating with the accounting software application.

37. The method of claim 1, comprising listing all suppliers set up in the accounting software application and allowing the user to select which suppliers are to be enabled.

38. The method of claim 1, comprising providing a second login for the user that is the same as a first login used by the user to connect to the accounting software application.

39. The method of claim 38, comprising denying access to the user if the first or second login fails.

40. The method of claim 1, comprising providing a wizard interface for allowing the user to perform at least one of the following tasks:
perform an initialisation routine to identify the user;
authorise the user;
set up a user account;
authenticate the user account;
activate the user account;
set up a new bank account for the user;
configure the user interfaces according to the accounting software application being used;
create and validate a beneficiary account;
synchronize suppliers and beneficiaries in the accounting software application with the API; and
determine in which folder they wish currency loss/gain to be automatically recorded in the accounting software application.

41. The method of claim 40, wherein the user account is a private account or a corporate account.

42. The method of claim 41, wherein the private account allows full control of the system.

43. The method of claim 41, wherein the corporate account allows the creation of multiple user accounts with different levels of user control.

44. The method of claim 43, wherein the different levels of user control comprise a master level allowing access to all functionality, an approver user level allowing the user to book and approve payments an view account summary, and a data entry user level which allows the user only to book payments and view account summary.

45. The method of claim 1, comprising providing a comparison between an exchange rate of an existing payment provider and the exchange rate provided from the online service.

46. The method of claim 45, wherein the comparison comprises a historic comparison of a foreign currency invoice previously entered or a current comparison of a foreign currency invoice being currently processed.

47. The method of claim 46, comprising using data from the comparison to populate a screen, a message or a pop-up to notify how much the client could have saved had he/she selected the currency exchange rate provided from the online service in the API.

48. The method of claim 47, comprising sending the data to a partner to alert the partner what the client could have saved.

49. The method of claim 48, wherein the data comprises at least one of client name, client ID, date, currency bought, currency sold, amount bought, margin paid to bank/provider, and potential partner revenue.

50. A computer readable medium storing a program for executing the method according to claim 1.

51. A global payment application in the form of an integrated application programming interface (API) for booking payments, the application being configured for interfacing with:
an accounting software application, the accounting software application configured for entering payment invoices in one or more currencies from one or more suppliers,
an online service for providing an exchange rate to the global payment application;
wherein the global payment application comprises:
a user interface for:
displaying the one or more payment invoices, the invoices having been previously entered in the accounting software application,
receiving a user's selection of invoices to be paid from the one or more invoices in the user interface, determining the total value of all invoices to be paid;
selecting a currency exchange rate provided from the online service to transfer the monies due from a bank account of the user to a beneficiary account of each of the one or more suppliers;
allowing the user to approve payments;
receiving a user's selection of currency exchange rate and payment approval, executing the funds transfer to each of the beneficiary accounts;
automatically posting the funds transfer to the accounting software application once confirmation of the funds transfer is received; and
automatically posting an exchange gain or loss in the accounting software application based on the funds transfer.

52. The application of claim 51, being configured for execution as a windows desktop application.

53. The application of claim 51, being configured to interface with an online banking service.

54. The application of claim 53, being configured to interface between the accounting software application, and each of the online service and the online banking service.

55. The application of claim 54, being configured such that data originating from and stored in the accounting software application is routed through the global payment application to the online banking service.
